(19) United States
(12) Patent Application Publication
(10) Pub. No.: US 2017/0015417 A1
(43) Pub. Date: Jan. 19, 2017

(54) Multi-Propulsion Design for Unmanned Aerial Systems

(71) Applicant: Reference Technologies Inc, Lafayette, CO (US)

(72) Inventor: Allen Paul Bishop, Lafayette, CO (US)

(21) Appl. No.: 14/839,960

(22) Filed: Aug. 29, 2015

Related U.S. Application Data
(60) Provisional application No. 62/044,010, filed on Aug. 29, 2014.

(51) Int. Cl. B64C 39/02; B64C 27/82; B64C 29/04

(52) U.S. Cl. CPC B64C 39/024; B64C 29/04; B64C 27/82; B64C 2027/8227; B64D 2027/026

(57) ABSTRACT

A propulsion system for a ducted fan vertical takeoff and landing aircraft (VTOL) powered by multiple electric motors with two, counter rotating electric motors comprising the primary thrust generation within a ducted fan component and 3 or more external electric motors providing lift, stability and directional control of the aircraft. Through the use of counter rotating ducted fans, the aircraft does not require the need for internal stators—either fixed or adjustable angle. Power to the electric motors is sourced by either onboard batteries, a ground based power source via a ground to aircraft tether, or an on board fuel cell or combustion engine driving an alternator.

### CROSS REFERENCE TO RELATED APPLICATIONS

This application claims the benefit of U.S. Provisional Patent Application No. 62/044,010, filed on Aug. 29, 2015, and titled “Multi-Propulsion Design For Unmanned Aerial Systems” which is incorporated by reference herein in its entirety for all purposes.

### BACKGROUND OF THE INVENTION

1. Field of the Invention

The present description relates generally to unmanned aerial vehicles and unmanned aircraft systems. More particularly, the present description relates to an unmanned aerial vehicle with vertical takeoff and landing (VTOL) capabilities comprising: a hybrid motor, externally controlled rotors, and a central ducted fan assembly with counter rotating propellers.

2. Description of Related Art

Unmanned aerial vehicles (“UAVs”) and unmanned aircraft systems (“UASs”), (UAV/UAS), are remotely piloted or autonomously piloted aircraft that can carry a variety of surveillance, intelligence, and reconnaissance (SIR) sensors as well as communications equipment; and deployable or non-deployable payloads. A UAV/UAS is capable of controlled, sustained, and level flight; and are often powered by either a gas turbine or a reciprocating internal combustion engine. A UAV/UAS may be remotely controlled or may fly autonomously based on pre-programmed flight plans or more complex dynamic automation systems.

UAV/UASs have become increasingly used for various applications where the use of manned flight vehicles is not appropriate or is not feasible. Such applications may include military situations, such as surveillance, intelligence, reconnaissance (SIR), target acquisition, data acquisition, communications relay, decoy, harassment, or supply flights. These vehicles are also used in a growing number of civilian applications, such as firefighting when a human observer would be at risk, police observation of civil disturbances or crime scenes, reconnaissance support in natural disasters, and scientific research, such as collecting data from within a hurricane.

Ducted fan vertical takeoff and landing (VTOL) UAV/UASs offer a distinct operational functionality in comparison to conventional fixed wing UAV/UASs. This increased functionality is related to the ability of the Ducted fan VTOL UAV/UAS to be “parked” at a specific altitude and allowed to hover (aka perch and stare) over a point of interest. In a perch and stare maneuver the UAV/UAS can be stopped in flight and any sensors on the UAV/UAS can be used to closely investigate a point of interest while the vehicle remains stationary.

A typical mission profile begins with the UAV/UAS ascending to a specified altitude. Once the UAV/UAS reaches its specified altitude, the UAV/UAS then cruises to a specified location and hovers at that location. Cruise, hover, and altitude changes may occur multiple times during a mission. The mission profile is completed with the UAV/UAS cruising to the landing location, descending, and landing at that location. Different power levels are required during the different portions of the mission profile. Currently, a gas turbine engine or a reciprocating internal combustion engine (“ICE”) are used to drive the rotating fan of ducted fan propelled UAV/UAS. A gas turbine and an ICE are designed to produce peak efficiency at a specific power and speed, often referred to as the design point. The efficiency is reduced when the power and speed are varied from the design point. Throughout the mission profile, the engine is operated at many different power and speed conditions, resulting in less than optimum efficiency for certain legs of the profile. When the engine is not operating at optimum efficiency, higher fuel consumption results.

Higher fuel consumption means the UAV cannot fly as far or as long as it could if the engine were operated at the design point throughout the entire mission profile. Due to weight limitations, ducted fan UAVs typically have only one source of propulsive power. This is because two of any of the aforementioned power sources on a UAV would be too heavy of a load, resulting in decreased vehicle performance. However, if the one source of propulsive power fails to operate during a mission, or operates at a lower, uncontrolled manner, the result could be an uncontrolled flight, or very likely, a crash. Also, due to weight constraints, ducted fan UAV/UASs with ICEs typically do not have an electrical starter or generator. Instead, electric power for flight is derived from an on-board battery. The battery level is slowly depleted during the mission. The depletion may limit flight time, thus limiting the utility of the vehicle. An ICE needs a significant torque applied to the crankshaft to be able to start. Typical small motors can supply high speed, but low torque. Without an electrical starter, ducted fan UAV/UAS cannot land in a remote location with its engine turned off and then start up again to take off and resume the mission or return to base. This capability, commonly referred to as “perch and stare,” is desirable because it allows the vehicle to fly to a remote location and land while remaining able to transmit data, such as video and still images, back to the operator.

Current ducted fan vehicles suffer from unwanted yawing due to rotor torque, which requires the ducted fan vehicles to use control vanes, rudders, or air outlets that are called “stators” to compensate for rotor torque yawing. This definition of “stators” is not found in the dictionary as it is a highly technical term specific to centrally ducted aerial vehicles, for the purposes of this patent “stators” shall mean air outlets for the redirection of force from a single propeller ducted fan to compensates for rotor torque.

Multi-rotor quadcopters and similar designs are more stable because the battery or payload weight is centralized while the propulsion is arranged peripherally around the central weight. However, they lack a large central motor, which necessarily means they lack the benefits a more efficient engine and larger rotor gives to flight duration and payload capability.

### SUMMARY

The scope of the present invention is defined solely by the appended claims and detailed description of a preferred embodiment, and is not affected to any degree by the statements within this summary. In addressing many of the problems experienced in the related art, such as those relating to motor suitability for vertical takeoff and landing applications, imbalance, and torque yawing issues in central ducted fan vehicles the detailed description offers the following solutions.

In one embodiment of an unmanned aerial vehicle (UAV) with vertical take off and landing capabilities (VTOL) an electrically powered dual mode propulsion system is described. This dual mode propulsion system provides for an electrically powered ducted fan with two or more counter rotating propellers (fans, rotors) aligned along the same axis of rotation which eliminate the need for stators since a yaw caused by rotor torque is eliminated by the counter rotating fans; the rotor torques essentially cancel each other out. The ducted fan assembly may be designed to accommodate about 95% of the UAV/UAS's gross weight. The secondary propulsion mode is provided by multiple external electrically driven rotors, which may also be ducted fans, mounted on the external periphery of the central ducted fan. This secondary propulsion source provides the necessary thrust to complete the lifting of the aircraft (5%) while maintaining a significant reserve of thrust to maintain flight control throughout the flight plan and flight environment.

In another embodiment, the dual mode propulsion system comprises a set of internal batteries powering two distinct thrust generators: 1), a ducted fan with two electric fan motors in a counter rotating assembly where the two electric fan motors may be stacked at a calculated distance from the inlet and outlet of the duct and are mounted in specific proximity to one another, allowing for maximum thrust efficiency; and 2), external electric rotor arms are symmetrically distributed around the periphery of the duct shroud.

In another embodiment, a dual mode propulsion system is described where the battery power is augmented by an internal electric alternator driven by an engine. The alternator produces the necessary electric power to operate the two counter-rotating ducted electric fans and the multiple external electric rotors. In addition, the reserve power produced by the alternator is used to power all onboard electronic components, including the autopilot, GPS/Compass control, hard points for carrying and releasing payloads as well as multiple SIR systems. The alternator also operates as an engine starter, allowing the UAV/UAS to land at a point of interest, shut down the gas engine and operate electronic components on battery or solar power. Once the mission is complete, the onboard electronic system will auto-start the engine/alternator allowing the UAV/UAS to take off and resume its mission flight profile.

In another embodiment, a dual mode propulsion system for a ducted fan aerial vehicle is provided whereby a data and power tether is used to provide power to the dual mode propulsion system. In this embodiment, the UAV/UAS does not have any onboard battery or engine/alternator equipment. This allows the UAV/UAS to remain airborne for indefinite periods of operation.

### BRIEF DESCRIPTION OF THE DRAWINGS

Various embodiments are described herein with reference to the following Drawings. Certain aspects of the Drawings are depicted in a simplified way for reason of clarity. Not all alternatives and options are shown in the Drawings and, therefore, the Claims are not limited in scope to the content of the Drawings.

### Figures

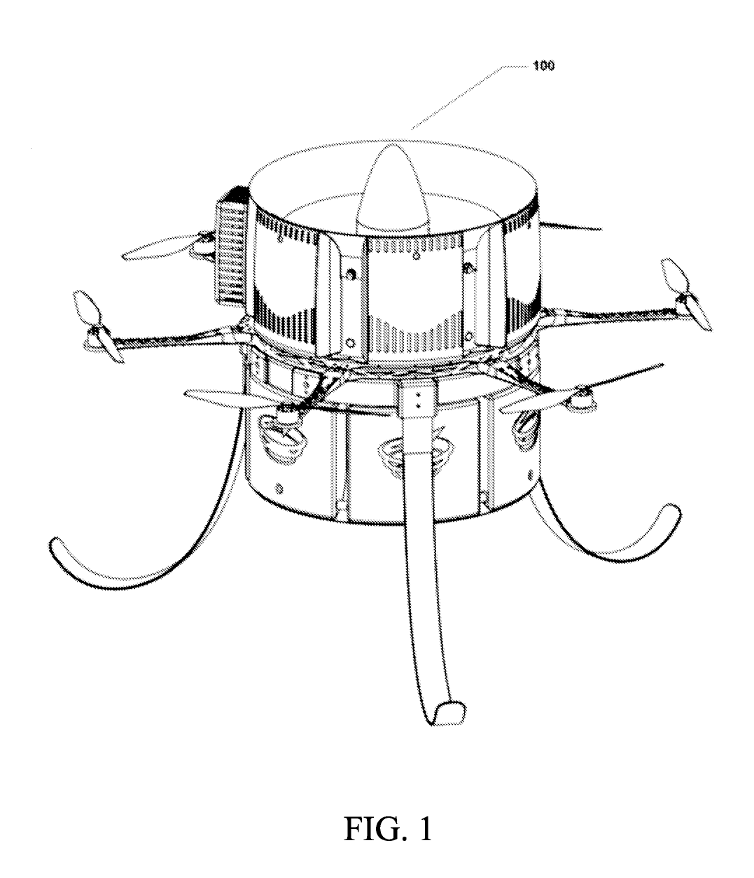

FIG. 1 illustrates a perspective view of a dual mode propulsion system for a ducted fan aerial vehicle, in accordance with an embodiment of the present disclosure.

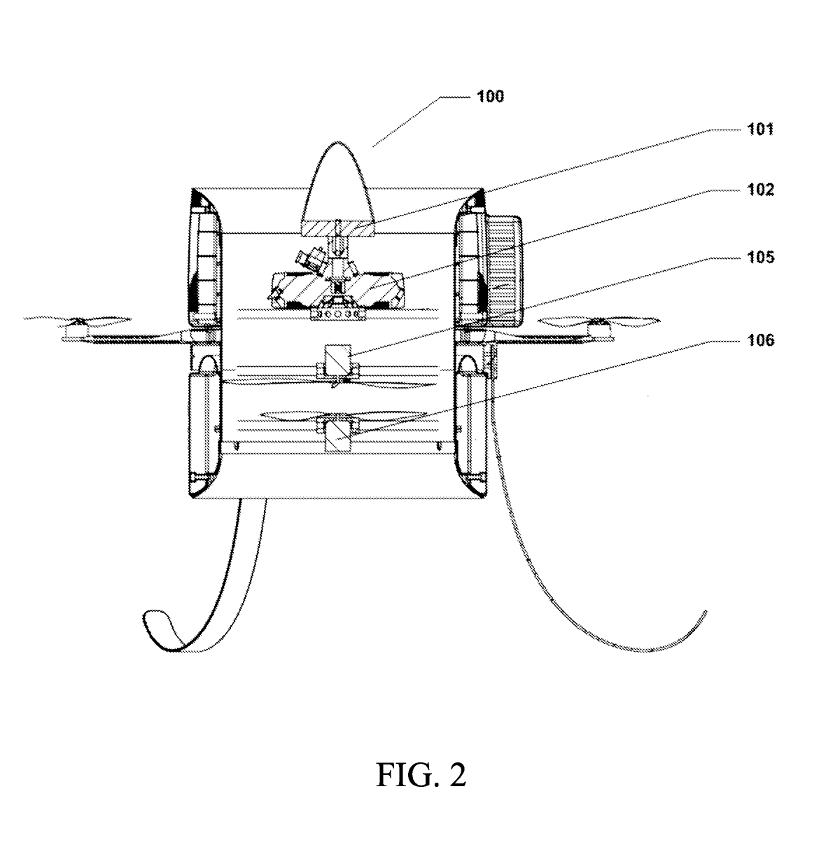

FIG. 2 illustrates a cut-away view of a dual mode propulsion system for a ducted fan aerial vehicle, in accordance with an embodiment of the present disclosure.

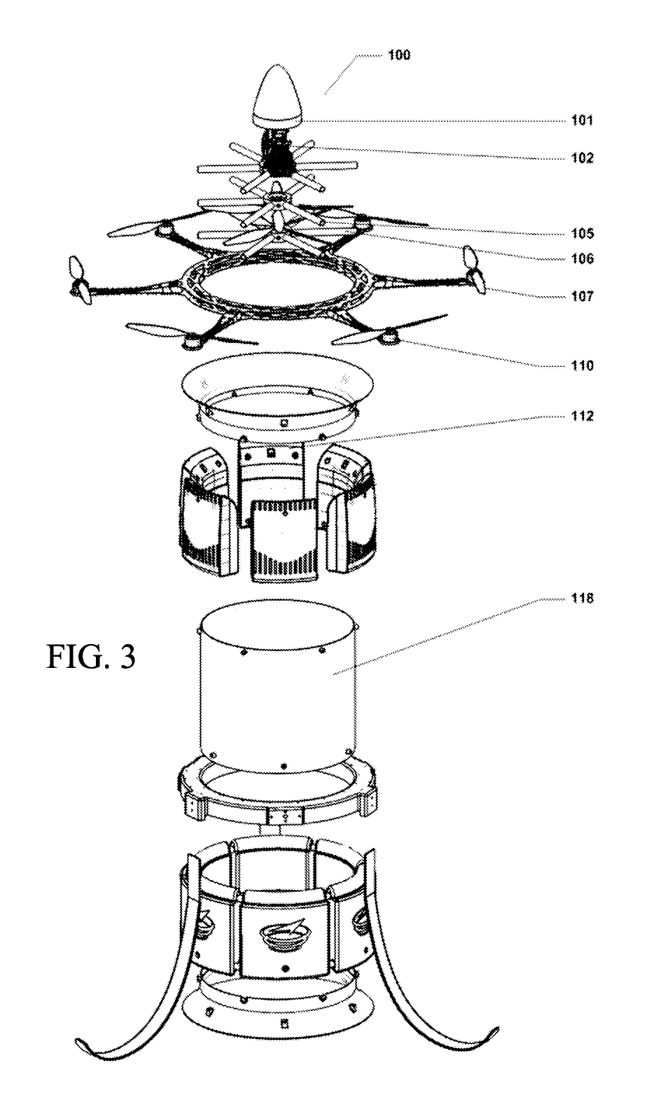

FIG. 3 illustrates an exploded view of a dual mode propulsion system for a ducted fan aerial vehicle, in accordance with an embodiment of the present disclosure.

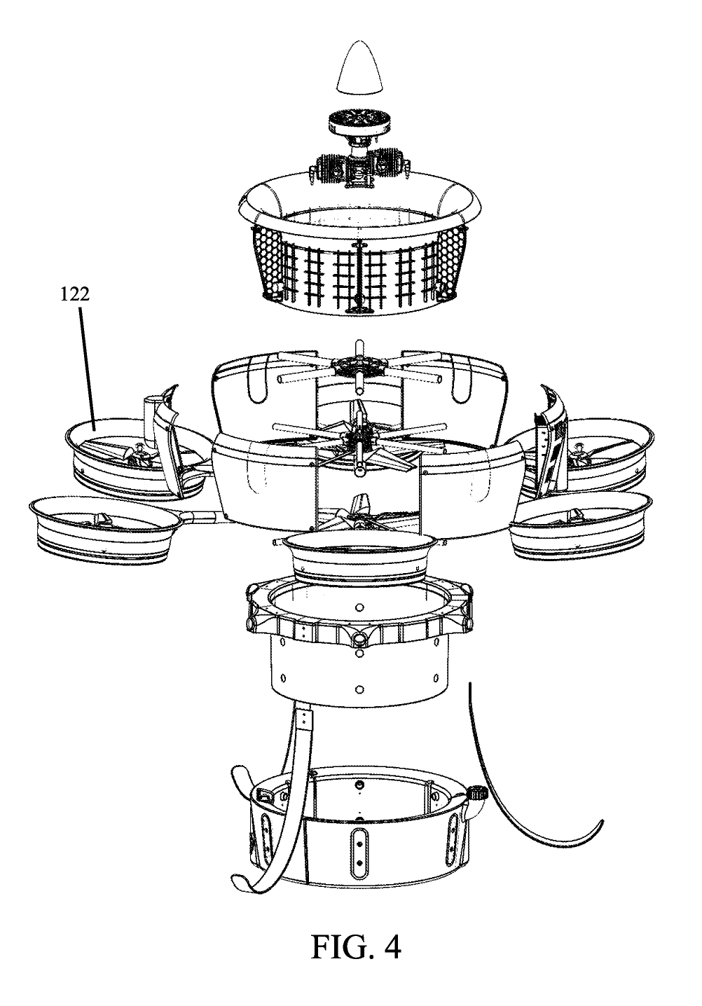

FIG. 4 illustrates an exploded view of a dual mode propulsion system for a ducted fan aerial vehicle with ducted peripheral motors, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### REFERENCES

100 Dual Propulsion Mode Ducted Fan Unmanned Aerial Vehicle
101 Alternator
102 Reciprocating Gas Engine
105 Upper Ducted Fan Rotor Assembly
106 Lower Ducted Fan Rotor Assembly
107 External Electric Propeller
110 External Electric Motor
112 Voltage Regulator
118 Central Duct
122 Ducted External Electric Motor and propeller

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

Generally, FIGS. 1 through 4 illustrate embodiments of dual propulsion mode ducted fan unmanned aerial vehicles (UAVs) 100 with vertical take off and landing capabilities (VTOL). The dual propulsion modes are a combination of two or more counter-rotating centrally ducted fans in combination with radially arranged open or ducted rotors. This dual arrangement of propulsion captures the advantage of the high thrust of a ducted fan while maintaining the stability and controllability of a multirotor configuration.

Ducted fans are a common design solution for a VTOL UAV. The present embodiments of a VTOL UAV 100, illustrated in FIG. 1, include a centralized ducted fan to provide heavy lift capability. The lift contribution of the ducted fan is expected to offset the weight of the cargo and part of the airframe. Ducted fans provide greater trust performance for a smaller volume when compared to open rotor aircraft. The ducting structure provides the additional benefits of blade noise reduction and convenient aircraft systems and payload mounting locations.

As illustrated in FIG. 2, a major improvement of this new design over prior central ducted fan UAV designs is that the present design uses two or more counter rotating rotors within the aircraft's central duct 118 to reduce unwanted yawing due to rotor torque. By spinning two propellers in opposite directions, the applied yawing force on the aircraft generated by an upper ducted fan rotor assembly 105 counteracts the opposite force generated by a second lower ducted fan rotor assembly 106. If these two forces are the same magnitude, the net yaw force on the vehicle caused by rotor torque equals zero. Ideally, the two electric fan motors may be stacked at a calculated distance from the inlet and outlet of the duct and are mounted in specific proximity to one another, allowing for maximum thrust efficiency.

Conventional helicopters solve the issue of rotor torque with an anti-torque tail rotor. VTOL ducted fans UAVs such as the RQ-16 T-Hawk MAV developed by Honeywell, counteract rotor torque by directing the flow exiting the duct using actuating stators. Actuating stators require heavy and complex stator control systems and the many moving parts dramatically increase the likelihood of loss of control and malfunction.

Another important improvement is the use of two electric motors in each of the internal rotor assemblies 105 and 106. Firstly, twin electric motor configuration eliminates the need for a heavy gearbox. Secondly, a rotor driven by a mechanical motor would need a gearbox attached axially in the duct 118 which would further obstruct the flow of air and decrease power. Additionally, due to the high rotational speed the gearbox would have to accommodate, it would need to be manufactured from heavy metallic materials and would be prone to failure. If you choose two identical electric motors it allows you to modularize the design, facilitating easy repair and replacement.

Each electric motor can also be controlled separately, allowing for differential torque on the rotors and therefore an additional way of controlling aircraft yaw allowing you to gently turn the aircraft one way or the other. The use of electrical motors also eliminates the need for a mechanical drive from the reciprocating engine as the engine 102 only powers the alternator 101 that then supplies the power to the electrical motors.

In another embodiment you can power the two rotors though a single electric motor connected to a gearbox. In this embodiment the engine could turn the alternator 101 at a fixed speed, allowing for a decrease in the weight of the voltage regulator 112. In another embodiment an all-electric battery powered version of the aircraft would be possible with little modification to the vehicle.

As illustrated in FIGS. 3 and 4, another important advancement in the field of unmanned aerial vehicles is the addition of external rotors to the central ducted fan design. Multirotor aircraft have long been used for VTOL UAS applications because of their stability and ability to adapt to quickly changing weather conditions. The present design can have 3 or more external rotors 107 driven by independent external electric motors 110. The lift contribution of these outboard motors may offset the remainder of the aircraft weight not propelled by the central ducted fan as well as provide for dramatically increased control and stability. FIG. 4 shows an embodiment where the external electric motors and propellers are also ducted 122. Ducted external propellers protect the rotors from being damaged should the vehicle bump into something.

One embodiment of a dual propulsion mode ducted fan unmanned aerial vehicle 100 may generate electrical power with a small reciprocating engine 102 with a high efficiency alternator 101. Power is delivered to the onboard electronic components and may be used to charge onboard batteries. The motor 102 and alternator 101 are ideally located coaxially to the central duct 118 primarily to maintain symmetric weight distribution and therefore stability. As illustrated in FIG. 3, the motor is located above the fan assemblies; however, balance is optimized when the motor 102 located below the fan assemblies. As an additional benefit, duct flow may provide cooling for the engine 102 when the aircraft is stationary or airflow is otherwise insufficient.

Information as herein shown and described in detail is fully capable of attaining the above-described object of the present disclosure, the presently preferred embodiment of the present disclosure; and is, thus, representative of the subject matter, which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. An unmanned aerial vehicle, comprising:
a central ducted fan;
three or more external rotors located peripherally around said central ducted fan.

2. The unmanned aerial vehicle of claim 1, wherein the central ducted fan comprises two or more counter rotating rotors with the same axis of rotation.

3. The unmanned aerial vehicle of claim 2, wherein the central ducted fan rotors are stacked at a distance from each other that allows for maximum thrust efficiency.

4. The unmanned aerial vehicle of claim 2, wherein the central ducted fan rotors each have their own motor.

5. The unmanned aerial vehicle of claim 4, wherein the motors for each rotor of the central ducted fan are electric.

6. The unmanned aerial vehicle of claim 1, wherein the external rotors are ducted.

7. The unmanned aerial vehicle of claim 1, further comprising an alternator.

8. The unmanned aerial vehicle of claim 1, further comprising a reciprocating gas engine

9. The unmanned aerial vehicle of claim 8, wherein the engine is located axially to the central ducted fan.

10. The unmanned aerial vehicle of claim 8, wherein the engine is located in the bottom half of the vehicle.
